(19) United States
(12) Patent Application Publication
(10) Pub. No.: US 2007/0101540 A1
(43) Pub. Date: May 10, 2007

(54) Self-centering trolley for horizontally sliding doors

(76) Inventor: James Martin, Pagosa Springs, CO (US)

Correspondence Address: PHILIP H. HAYMOND, 7545 IRVINE CENTER DRIVE, SUITE 200, IRVINE, CA, 92618-2933, US

(21) Appl. No.: 11/529,754

(22) Filed: Sep. 27, 2006

Related U.S. Application Data
(60) Provisional application No. 60/721,520, filed on Sep. 27, 2005.

(51) Int. Cl. E05D 15/06

(52) U.S. Cl. 16/97

(57) ABSTRACT

An adjustable self-centering trolley for suspending a horizontally sliding door such as a shower door from an overhead track.

### RELATED APPLICATIONS

This specification hereby incorporates by reference and claims priority of U.S. provisional patent application Ser. No. 60/721,520, Martin inventor, filed Sep. 27, 2005 and entitled Self-Centering Trolley for Horizontally Sliding Doors.

### FIELD OF THE INVENTION

This invention relates to horizontally sliding doors and more particularly to horizontally sliding shower doors.

### BACKGROUND OF THE INVENTION

Horizontally sliding doors are typically carried along a track in an overhead bracket. The door is hung from one or more trolleys having rollers or wheels that run along an overhead track.

Many of these doors of the prior art sometimes bind in the overhead track through torsional forces, causing the door to be difficult to move. For example if the wheels are not originally installed to distribute weight on both wheels equally, or twist during use, they are off-centered with an unequal load on the two wheels of the trolley. The wheels may then bind or move with more difficulty when the door is moved because the leading wheel on each trolley bears a greater load than the trailing wheel. Two trolleys are typically used on a door or window and if one or both of them do not hang evenly from the track then moving the door may be difficult.

What is needed then is a self-centering door trolley that will dynamically center itself in response to use.

### SUMMARY OF THE INVENTION

A solution to the above has been devised. A trolley for supporting a door or window from a track in an overhead bracket is disclosed, the trolley comprises an elongate member having two rollers affixed on one end that are adapted to move in an overhead bracket track. At the other end of the member is a pivot that affixes to the door being carried by the trolley, the door is pivotally affixed to the pivot. The trolley member can be formed from two plates joined together and the pivot is affixed to and sandwiched between the two plates. In the preferred embodiment the pivot further includes a bushing made of elastic material such as neoprene. When the wheels are placed in the track to suspend the door, the trolley will rotate about the pivot and orient itself in the track and relative to the door to automatically more evenly distribute the weight of the door between the two rollers resting in the track.

At the end of the trolley member distal the pivot, flanges or arms can be extended at an angle to the length of the member and each flange or arm adapted to be affixed to a roller at a plurality of points, so that a user can adjust the distance between the door and the rollers by selecting a point of attachment for each roller prior to installing the door on the track. In the preferred embodiment each flange or arm has a plurality of voids formed in the flange or arm to be coupled with a roller by an axle inserted in a void and the roller.

The trolley can be used in a system including an overhead bracket having a track adapted to support the rollers of the trolley. In the preferred embodiment the overhead bracket is of a generally concave U-shape and the track is on the inside of the bracket. Alternatively, the track might be formed on an exterior of a side of the bracket or even the top of the bracket. In any of these embodiments more than one track and trolley system can be included in a bracket, a plurality of tracks, and each track supports a door or window and the track is oriented on the bracket to allow the doors to move or slide past relative each other. In a typical shower door application for example two tracks will be formed on the interior of the bracket, and two doors will slide past each other to allow access to the shower.

In a method of the present invention, one or more trolleys are pivotally affixed to a door and the rollers or wheels are placed in a track formed in the overhead bracket.

### BRIEF DESCRIPTION OF THE DRAWINGS

FIG. 1 is a side view of the trolley of the present invention adjacent a track shown in an end view of an overhead bracket.

FIG. 2 is a front view of the trolley of the present invention.

FIG. 3 is a schematic side view of trolleys of the present invention and end view of an overhead bracket.

FIG. 4 is a schematic side view of joined plates forming the trolley of the present invention, without rollers affixed.

FIG. 5 is a schematic front view of the trolley of the present invention, without rollers affixed.

FIG. 6 is a back view of the door trolley of the present invention.

FIG. 7 is a side view of the door trolley of the present invention.

FIG. 8 is a side view of the trolley of the present invention resting in the track of an overhead bracket.

FIG. 9 is a perspective view of the trolley of the present invention resting in the track of an overhead bracket.

FIG. 10A is a schematic side view of another embodiment of the present invention, with an embodiment of an overhead bracket.

FIG. 10B is a schematic side view of yet another embodiment of the present invention, with yet another embodiment of an overhead bracket.

### DETAILED DESCRIPTION OF THE INVENTION

The following description, and the figures to which it refers, are provided for the purpose of describing examples and specific embodiments of the invention only and are not intended to exhaustively describe all possible examples and-embodiments of the invention.

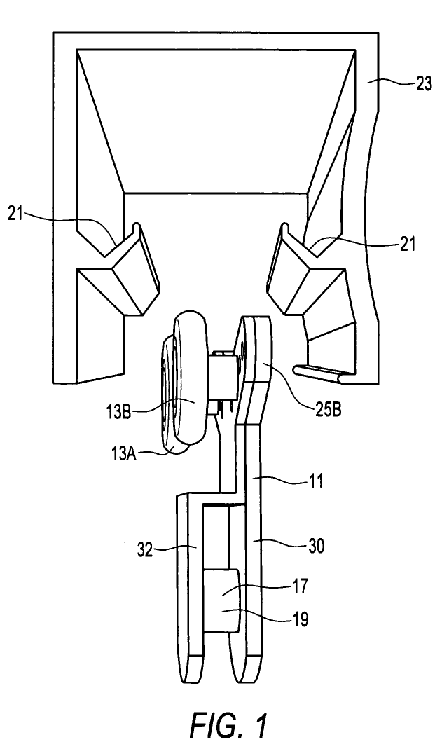

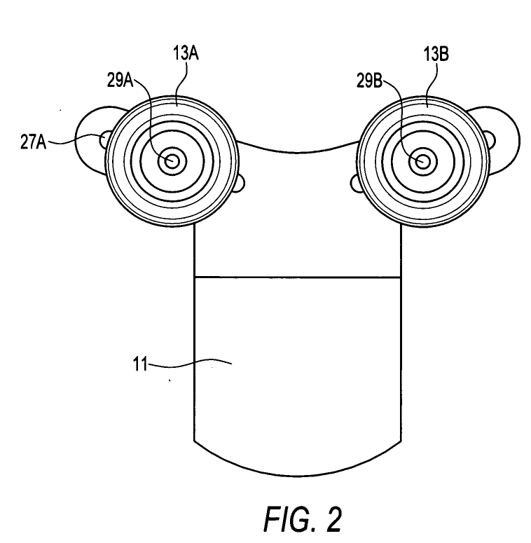

Referring now to FIGS. 1-5 a trolley 11 having a plurality of wheels or rollers 13A and 13B is provided that is attached to a door 15 on a pivot 17, to allow the trolley to move rotationally about the pivot point (as indicated by arrow). A bushing 19 preferably made from an elastic material such as neoprene is provided on the pivot pin 17 to facilitate rotation. The rollers 13A and 13B of the trolley 11 are placed in a groove or track 21 in an overhead bracket 23, whereby the door 15 is suspended from the overhead bracket 23. This rotational movement allows the wheels 13A, 13B of the trolley 11 to distribute the weight of the door equally on each wheel on a track or groove 23, making the trolley self-centering.

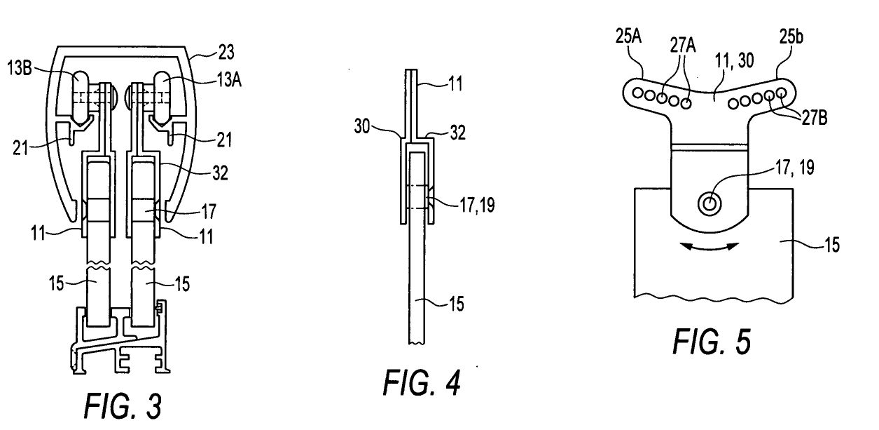

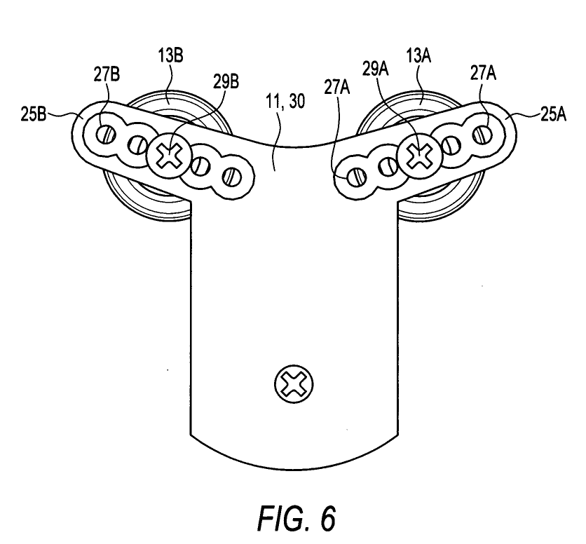

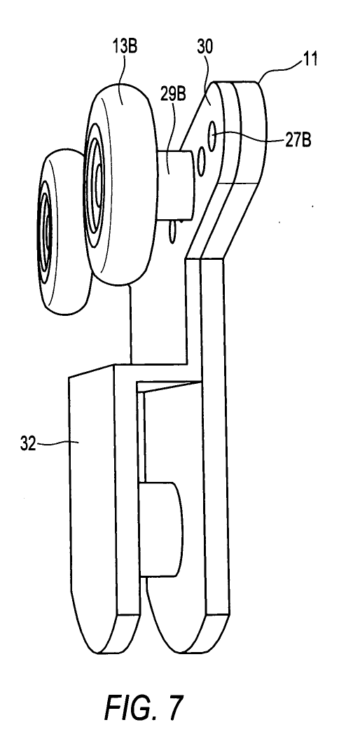

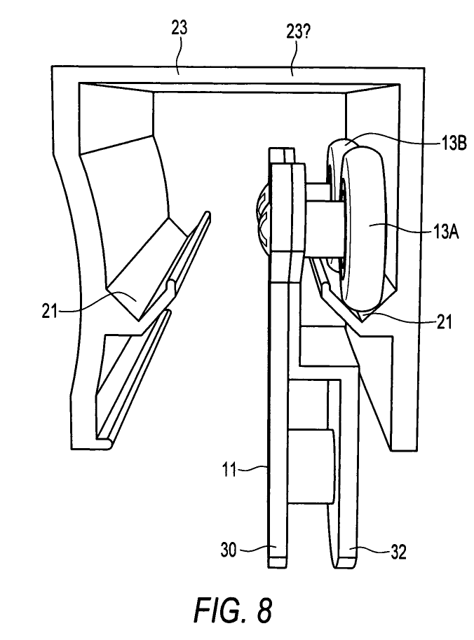

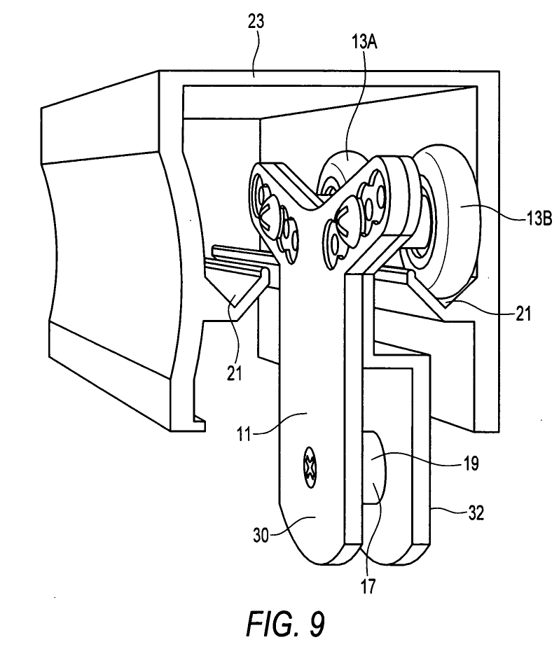

In the preferred embodiment of the trolley 11 of the present invention is used with a door 15 made of a pane of plastic or glass as a shower enclosure door. Two rollers 13A and 13B are used on the trolley 11 and the bushing 19 is made of neoprene. The door is suspended from a track or groove 21 formed inside a U-shaped overhead bracket 23. Two doors 15 are installed in overhead bracket 23, that may slide over one another, as shown in FIG. 3.

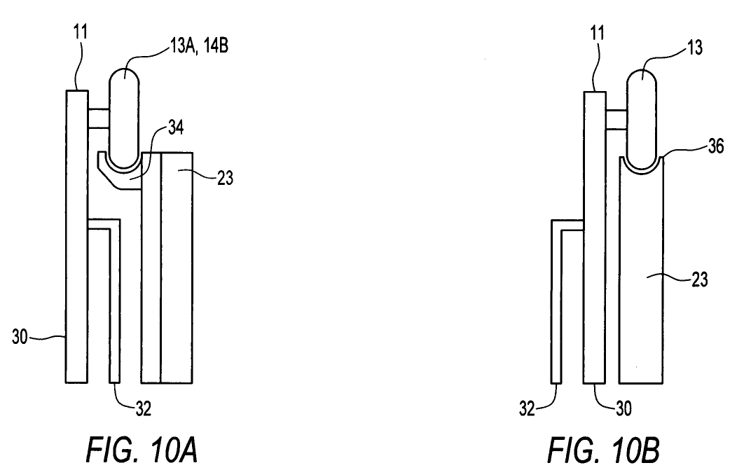

Alternatively, the rollers could be suspended from a groove or track 34 formed outside of the overhead bracket 23, as shown in FIG. 10A or even ride along the top of an overhead bracket itself 36 as shown in FIG. 10B.

In the preferred embodiment of the trolley 11 of the present invention is made of joined first plate 30 and second plate 32 having flanges or arms 25A and 25B extending laterally at an upward angle. Voids 27A and 27B are formed in the flanges to receive axles 29A and 29B holding rollers 13A and 13B respectively. In this construction a user can therefore select a pair of voids 27A and 27B to fix wheels 13A and 13B to, to adjust the distance of the door from the track when installing the door. First plate 30 is affixed to pivot pin 17 at one end and second plate 32 is formed to be attached to and support the pivot at its opposite end. Alternatively the trolley 11 could be formed from a single piece of rigid material such as metal or plastic.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention.

What is claimed is:

1) A trolley for supporting a door or window from a track in an overhead bracket, comprising:
an elongate member having two rollers affixed on one end that are adapted to move in an overhead bracket track, and a pivot located on, the opposite end of the member, whereby when a door is pivotally affixed to the pivot and the wheels are placed in the track to suspend the door, the trolley will rotate about the pivot and orient itself relative the door to more evenly distribute the weight of the door between the two rollers resting in the track.

2) The trolley of claim 1 where the pivot further includes a bushing made of elastic material.

3) The trolley of claim 2 where the elastic material is neoprene.

4) The trolley of claim 1 where the member is formed from two plates joined together and the pivot is affixed to both plates.

5) The trolley of claim 1 where the second roller member end has flanges or arms that extend at an angle to the length of the member and each flange or arm is adapted to be affixed to a roller at a plurality of points, whereby a user can adjust the distance between the door and the rollers by selecting a point for each roller prior to installing the door on the track.

6) The trolley of claim 5, wherein the plurality of points on each flange or arm are voids formed in the flange or arm adapted to be coupled with a roller by an axle inserted in a void.

7) The trolley of claim 6 where the member is formed from two plates joined together and the pivot is affixed to both plates, and the pivot includes a bushing made of elastic material.

8) A system for supporting a door or window from a track in an overhead bracket, comprising:
an overhead bracket having a track adapted to support the rollers of a trolley,
wherein the trolley comprises an elongate member having two rollers affixed on one end that are adapted to move in the track, and a pivot located at the opposite end of the member, whereby when a door is pivotally affixed to the pivot and the wheels are placed in the track to suspend the door, the trolley will rotate about the pivot and orient itself relative the door to more evenly distribute the weight of the door between the two rollers resting in the track.

9) The system for supporting a door or window of claim 8, where the bracket is of a generally concave U-shape and the track is on the inside of the bracket.

10) The system for supporting a door or window of claim 8, where the track is formed on the exterior of a side of the bracket.

11) The system for supporting a door or window of claim 8, where the track is formed on the top of the bracket.

12) The system for supporting a door or window of claim 8, where the overhead bracket has a plurality of tracks and each track supports a door or window, wherein the tracks of the bracket are oriented to allow each door to move relative another door along its track for a distance.

13) The system for supporting a door or window of claim 12, where the bracket is of a generally concave U-shape and has two tracks, each on the opposite side of the interior of the bracket.

14) The system for supporting a door or window of claim 13, where the trolley member is formed from two plates joined together and the pivot is affixed to both plates, the pivot includes a bushing made of elastic material, and where the second roller member end of each trolley has flanges or arms that extend at an angle relative the length of the member and each flange or arm is adapted to be affixed to a roller at a plurality of points on the flange or arm, whereby a user can adjust the distance between the door and the rollers by selecting a point for each roller when installing the door on the track using the trolley.

15) A method for suspending a door or window from a track in an overhead bracket, comprising the steps of:
providing an overhead bracket having a track adapted to support the rollers of a trolley comprising an elongate member having two rollers affixed on one end that are adapted to move in an overhead bracket track, and a pivot located at the opposite end of the member, whereby when a door is pivotally affixed to the pivot and the wheels are placed in the track to suspend the door, the trolley will rotate about the pivot and orient itself relative the door to more evenly distribute the weight of the door between the two rollers resting in the track,
pivotally affixing the pivot to a door, and
hanging the door by placing the rollers or wheels of the trolley in the track of the overhead bracket.

16) The method claim 15 where the pivot further includes a bushing made of elastic material.

17) The method of claim 15 where the overhead bracket has a plurality of tracks and each track supports a door or window, wherein the tracks of the bracket are oriented to allow each door to move along its track for a distance relative another door.

18) The method of claim 17, where the track is formed on the exterior of the bracket.

19) The method of claim 17, where the bracket is of a generally concave U-shape and has two tracks, each on the opposite side of the interior of the bracket.

20) The method of claim 17, where the trolley member is formed from two plates joined together and the pivot is affixed to both plates, the pivot includes a bushing made of elastic material, and where the second roller member end of each trolley has flanges or arms that extend at an angle relative the length of the member and each flange or arm is adapted to be affixed to a roller at a plurality of points on the flange or arm, whereby a user can adjust the distance between the door and the rollers by selecting a point for each roller when installing the door on the track using the trolley.
